(19) United States
(12) Patent Application Publication
(10) Pub. No.: US 2025/0307741 A1
(43) Pub. Date: Oct. 2, 2025

(54) CUSTOMIZABLE COMMUNICATION PROCESS FLOW PATH METRICS

(71) Applicant: Salesforce, Inc., San Francisco, CA (US)

(72) Inventors: William Robert Jennings, II, Indianapolis, IN (US); Brian Robert Brechbuhl, Carmel, IN (US); Elisa Krebs, Lubbock, TX (US)

(21) Appl. No.: 19/029,862

(22) Filed: Jan. 17, 2025

Related U.S. Application Data
(60) Provisional application No. 63/572,872, filed on Apr. 1, 2024.

(51) Int. Cl. G06Q 10/0631; G06Q 10/0639

(52) U.S. Cl. CPC G06Q 10/06316; G06Q 10/06395

(57) ABSTRACT

A computing device of a data processing system may receive an indication of a creation of a communication process flow object that includes a set of paths for a set of actions that control electronic communications between an entity and a set of users. The computing device may receive a first user input indicating a goal for the set of paths where the goal is based on data stored within an external data platform. The computing device may then route at least a subset of the set of users via one or more paths of the set of paths based on a result of the one or more paths satisfying the goal for the set of paths of the communication process flow. Further, the computing device may distribute a subset of the electronic communications to the subset of the set of users in accordance with the one or more paths.

### CROSS REFERENCE

The present application for patent claims priority to and the benefit of U.S. Patent Application No. 63/572,872 by Jennings et al., entitled “CUSTOMIZABLE COMMUNICATION PROCESS FLOW PATH METRICS,” filed Apr. 1, 2024, assigned to the assignee hereof, and is expressly incorporated by reference in its entirety herein.

### FIELD OF TECHNOLOGY

The present disclosure relates generally to database systems and data processing, and more specifically to customizable communication process flow path metrics.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a data processing system that supports customizable communication process flow path metrics in accordance with aspects of the present disclosure.

FIG. 2 shows an example of a computing system that supports customizable communication process flow path metrics in accordance with aspects of the present disclosure.

FIG. 3 shows an example of a path variation generation diagram that supports customizable communication process flow path metrics in accordance with aspects of the present disclosure.

FIG. 4 shows an example of a path variation testing diagram that supports customizable communication process flow path metrics in accordance with aspects of the present disclosure.

FIG. 5 shows an example of a user interface that supports customizable communication process flow path metrics in accordance with aspects of the present disclosure.

FIG. 6 shows an example of a process flow that supports customizable communication process flow path metrics in accordance with aspects of the present disclosure.

FIG. 7 shows a block diagram of an apparatus that supports customizable communication process flow path metrics in accordance with aspects of the present disclosure.

FIG. 8 shows a block diagram of a communication allocation module that supports customizable communication process flow path metrics in accordance with aspects of the present disclosure.

FIG. 9 shows a diagram of a system including a device that supports customizable communication process flow path metrics in accordance with aspects of the present disclosure.

FIG. 10 shows a flowchart illustrating methods that support customizable communication process flow path metrics in accordance with aspects of the present disclosure.

### DETAILED DESCRIPTION

In some examples, users or administrators of a communication process flow management system may generate one or more communication process flows that include sets of actions to control communications between an entity (e.g., an organization of the user or the administrator) and a set of users. In some cases, the set of actions may include electronic communication messages (e.g., email messages), wait durations, follow-up messages, or any combination thereof. When generating a communication process flow, a user or administrator may generate a set of variations for one or more actions of the communication process flow. In some examples, when generating action variations, a user may determine to generate one or more paths for the different combinations of action variations. Further, in some cases, a user may generate a set of variations for two or more actions, thus increasing a quantity of action variation combinations for a path of the communication process flow. To determine whether a respective path of the communication process flow is successful, users may observe and analyze user engagement metrics based on interactions with a communication object. However, such analysis may be inefficient in determining if a respective path of the communication process flow is successful in a goal beyond a user engaging with a communication object, thus resulting in inaccurate path success determinations.

To support a more robust and accurate system of determining whether a respective path is successful, the techniques of the present disclosure may enable the use of one or more artificial intelligence (AI) or machine learning (ML) models (e.g., AI/ML models). For example, in response to receiving an indication of a creation of a communication process flow, a system (e.g., an application, a service, a server, a cloud-based system, or any combination thereof) may receive one or more user inputs indicating an automation event (e.g., a goal) for a set of paths of the communication process flow. An automation event may be a goal for a communication process flow that can be used to trigger one or more actions. Further, the automation event may be based on data that is stored within a data platform that is external and separate from the communication process flow. The system may then utilize AI/ML models to analyze the performance of a set of paths of the communication process flow that include different combinations of actions and action variations to route a subset of users via one or more paths based on a result of the one or more paths satisfying a goal. Therefore, a subset of the electronic communications may be distributed to the subset of users in accordance with the one or more paths.

In some examples, during the execution of the communication process flow, a server may receive an indication that the results of one or more paths have a higher likelihood of satisfying an automation event (e.g., goal) relative to the remaining paths of the communication process flow. Further, in some cases, similar to how the paths of the communication process flow may be indicative of combinations of action variations of the actions of the communication process flow, a server may receive one or more user inputs that indicate two or more automation events that are different from each other. Therefore, the paths of the communication process flow may also include combinations of two or more automation event variations. Additionally, or alternatively, an AI/ML model may generate an automation event for the communication process flow based on an indication of a first automation event, the data of the actions for the communication process flow, the data stored within the data platform, or a combination thereof.

Aspects of the disclosure are initially described in the context of an environment supporting an on-demand database service. Additional aspects of the disclosure are described with reference to a computing system, a path variation generation diagram, path variation testing diagram, a user interface, and a process flow. Aspects of the disclosure are further illustrated by and described with reference to apparatus diagrams, system diagrams, and flowcharts that relate to communication process flow path variations.

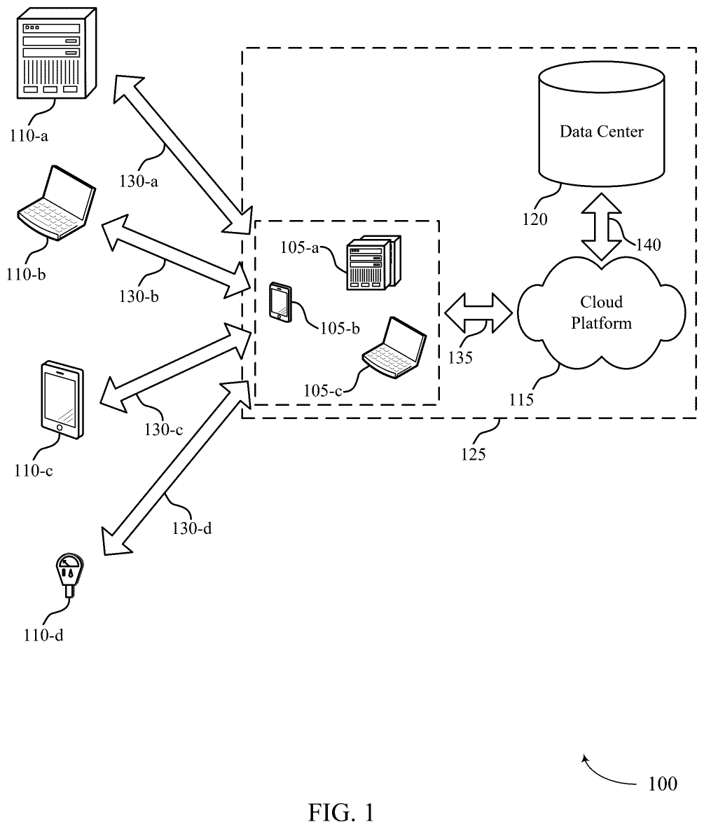

FIG. 1 illustrates an example of a system 100 for cloud computing that supports customizable communication process flow path metrics in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may support the generation of a communication process flow that includes a set of actions to control electronic communications between an entity (e.g., a tenant) and a set of users. For example, the communication process flow may control an organization or company transmitting a marketing campaign email to a set of users associated with the organization (e.g., users that purchase products from the organization). In some cases, a marketing user or a set of marketing users of the organization may generate a set of variations for at least two actions of the communication process flow. For example, the marketing users may generate a set of variations of a subject line of an email that is transmitted to a set of users. Further, in some cases the marketing users may determine one or more wait durations before transmitting a follow-up email to respective users and a set of variations for the subject line of the follow-up email message. The user may then generate a first path and a second path for the communication process flow to determine whether a respective subject-line variation is relatively more effective than the others. Further, the user may be capable of receiving one or more user engagement metrics to determine whether a path is relatively more successful. For example, a user may determine that if more users open a first email variation associated with a first subject-line variation opposed to a second email variation associated with a second subject-line variation, the user may determine the first email variation and the corresponding path to be more effective.

However, if a goal of the marketing campaign is to convince users to purchase one or more products from an organization, users may be unable to determine if such goal is satisfied based on user engagement metrics. Thus, to provide relatively more efficient and reliable results, the techniques of the present disclosure may enable users to generate goals or automation events for a communication process flow that are based on data stored within a data platform (e.g., a data center 120 or a cloud platform 115). For example, a user may generate a goal that uses purchase data stored within the data platform to determine if a user purchases a specific product based on receiving the email of the marketing campaign. Further, the techniques of the present disclosure may describe the system 100 using AI/ML models to analyze the data from one or more different sources within the data platform that may be associated with one or more different data formats to determine the satisfaction of a goal. For example, the data platform may include purchase data from an e-commerce website, inventory data of the e-commerce products from a warehouse that physically stores products, shipping data from a shipping service, payment data from a financial institution service, or any combination thereof. Therefore, due the data within the data platform being from multiple different sources and being within multiple different formats, the techniques of the present disclosure may describe an AI/ML model being used to analyze such data to determine if a goal for a respective path of a communication platform is satisfied.

Thus, to determine the accuracy of respective paths, the system 100 may monitor the performance of the set of paths to determine which paths are relatively more successful (e.g., based on satisfying the goal or automation event). Based on such monitoring, the system 100 may use AI/ML models to dynamically allocate traffic to the relatively more successful paths. For example, an automation event of a respective path may be configured that if satisfied relatively more frequently, the automation event may trigger a weight to the respective path to be adjusted such that the AI/ML models can allocate relatively more traffic to the respective path. Moreover, the automation event may be used to train the AI/ML models. For example, as an automation event or goal of a respective path is satisfied (e.g., an expression indicated by a user equals a value of true or 1), the AI/ML models may be updated to understand that the respective path may be a successful path.

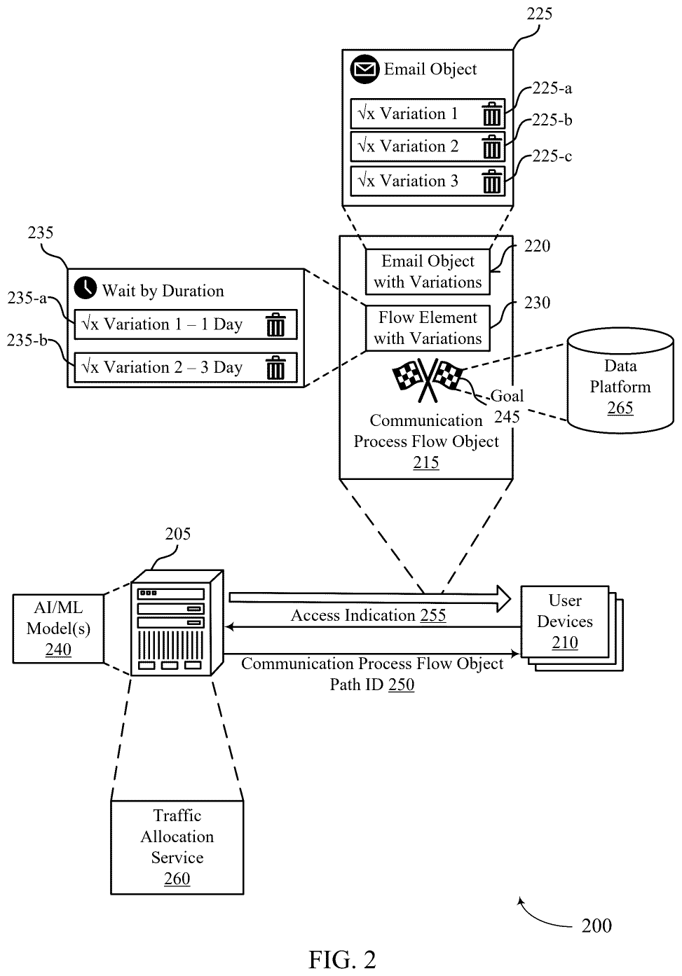

In another example, if a respective path is relatively unsuccessful (e.g., rarely satisfies the automation event or goal), the AI/ML models may learn and refrain from routing users to the respective path. Further, if a respective path is relatively successful, the AI/ML models may determine to increase the quantity of users being routed to the respective path. In some examples, the automation event may be associated with routing users to a respective path such that if an automation event equals a value of true a quantity of times that satisfies a threshold, the AI/ML models may route relatively more users to the respective path. Additionally, or alternatively, if the automation event equals a value of false (e.g., the goal of the path is not met) a quantity of times that satisfies a threshold, the AI/ML models may route relatively less users to the respective path. Moreover, such techniques of the present disclosure may provide a relatively more efficient and reliable process of allocating traffic between the set of paths of a communication process flow due to the increase in accuracy of determining success of a respective path. Therefore, the techniques of the present disclosure enables AI/ML models to automatically analyze result data of the respective paths of the communication process flow to determine a more efficient and reliable traffic allocation pattern. Further descriptions of the techniques of the present disclosure may be described elsewhere herein, such as with reference to FIGS. 2-6.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 shows an example of a computing system 200 that supports customizable communication process flow path metrics in accordance with aspects of the present disclosure. In some examples, the computing system 200 may implement or be implemented by the system 100. For example, the computing system 200 may include a server 205 and one or more user devices 210 which may be examples of devices or services or may be implemented by devices or services described with reference to FIG. 1. For example, the server 205 and the one or more user device 210 may be examples of cloud clients 105 or contacts 110 described with reference to FIG. 1. Further, the computing system 200 may be a multi-tenant system or a part of a multi-tenant system such that a user may be associated with a respective tenant of the multi-tenant system.

In some examples, a user or administrative user may access a user interface supported by the server 205 to configure a communication process flow object 215 to control electronic communications between an entity and a set of users (e.g., a set of users associated with the one or more user devices 210). For example, the user may be an administrative user of an organization (e.g., a tenant of a multi-tenant system) that transmits marketing emails to users via the communication process flow object 215 and the user may generate one or more versions of the email and test the one or more versions against each other. In some cases, the user may generate one or more paths of the communication process object 215 to experiment which email version may be more successful. In some examples, a path may be an example of a set of steps that the server 205 may perform for a respective user. For example, the user may manually generate a first path that initially transmits a first version of an email, waits 2 days for a response, and then sends a first version of a follow-up email and a second path that initially transmits a second version of the email, waits 3 days for a response, and then sends a second version of the follow-up email. However, such testing may omit some possible combinations of paths due to the user interface of the server 205 lacking an ability for a user to generate a relatively large set of paths and an ability to generate variations for each possible action of a communication process flow object 215.

Therefore, in some examples, users may be capable of adding variations of actions of the communication process flow object 215. In some examples, the actions of the communication process flow object 215 may also be referred to as objects or elements elsewhere herein. For example, the communication process flow object 215 may include an email object 220 that is associated with one or more email object variations 225 (e.g., an email object variation 225-a, an email object variation 225-b, an email object variation 225-c, or any combination thereof) generated by a user. In some cases, the one or more email object variations 225 may include separate content, subject lines, images, links, or any combination thereof. Further, a user may generate the one or more email object variations 225 for each separate variation. For example, the email object variation 225-a may be associated with a first subject line of an email and the email object variation 225-b may be associated with a second subject line of an email. Moreover, in some cases, users may use an AI/ML model 240 of the server 205 to generate different variations of portions of an email. In some examples, a generative AI model which may be an example of a type of AI/ML model 240 may be used to generate the email variations. Further, in some cases, users may use large language models (LLMs) to generate multiple different variations of a subject line based on the content of an email. LLMs may be an example of an AI/ML model 240 (e.g., a generative AI model) that is capable of generating text from an input. Further, LLMs may be trained on relatively large corpuses of text data and are capable of processing relatively large amounts of data. Therefore, LLMs may be capable of responding to user queries. For example, a user may query an LLM to generate 5 different email subject line suggestions based on the body of an email that the user provides to the LLM. Thus, the computing system 200 may use LLMs to generate one or more email object variations 225.

Further, the communication process flow object 215 may include a flow element 230 that controls the flow or timing of transmitting messages (e.g., emails). In accordance with the techniques of the present disclosure users may be capable of generating one or more flow element variations 235 for the flow element 230 (e.g., a flow element variation 235-a, a flow element variation 235-b, or a combination thereof). In some cases, the one or more flow element variations 235 may represent different wait durations for sending a follow-up email to a respective user. For example, the flow element variation 235-a may indicate a wait duration of one day and the flow element variation 235-b may indicate a wait duration of three days. In some cases, the one or more flow element variations 235 may also be generated via LLMs. However, currently, to determine whether a respective path of the communication process flow object 215 is successful, the server 205 may analyze user engagement data associated with the one or more email object variations 225 of the email object 220 which may be inaccurate as the user engagement data may be unable to indicate whether a goal was obtained. For example, if the communication process flow object 215 is used for marketing to attempt to have a user purchase goods from an e-commerce website, the server 205 may be unable to determine if a respective path of the communication process flow object 215 results in more users purchasing goods based on the user engagement data from a respective path.

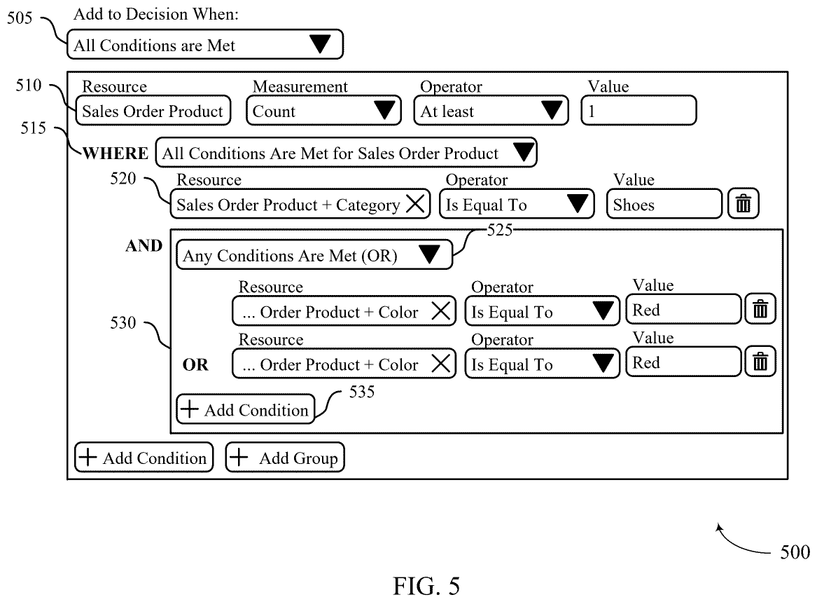

Therefore, the techniques of the present disclosure may enable users to generate one or more goals 245 for the communication process flow object 215 that are based on data within a data platform 265 that is separate from the communication process flow object 215. In some cases, the one or more goals 245 may also be referred to as automation events as described elsewhere herein. For example, the data platform 265 may include data associated with purchase data from merchant services that can indicate an amount spent by a respective user, data associated with items of the e-commerce website that can indicate which items are purchased by a respective user, among other types of data. Further, a user may use the AI/ML models 240 to analyze the data stored within the data platform 265 and determine whether a goal condition or automation event is satisfied, as described elsewhere herein, such as with reference to FIG. 5. Therefore, the communication process flow object 215 may also include the goal 245 to determine if a path of the communication process flow object 215 is successful.

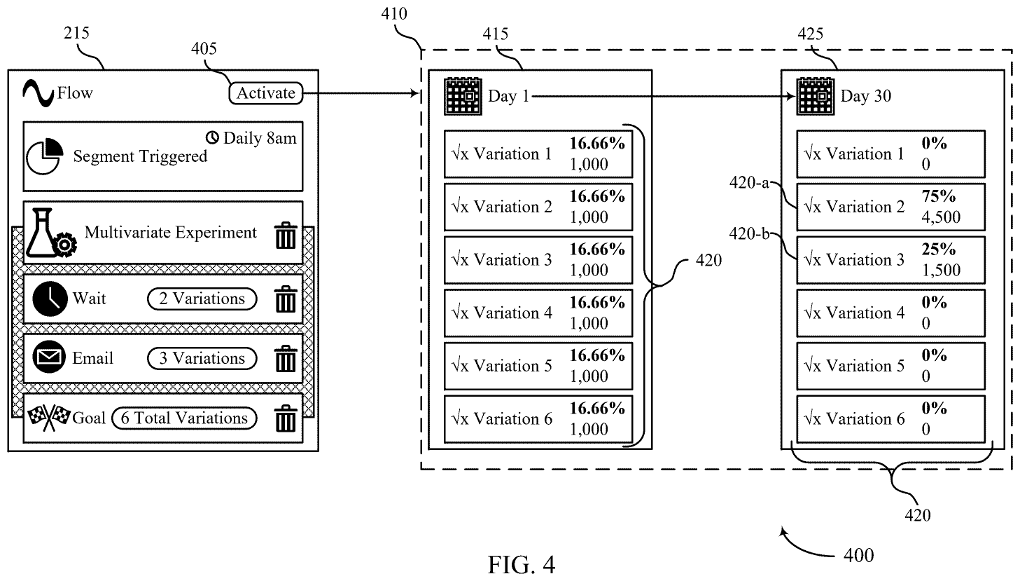

Further, in some examples, users may generate two or more variations for each action of the communication process flow object 215. Therefore, a quantity of combinations of action variations of the communication process flow object 215 may be relatively large. Thus, to provide users the ability to generate a path for each possible combination of action variations, the server 205 may implement one or more AI/ML models 240 to manage the one or more action variations. For example, a user may use an AI/ML model 240 to generate a path for each possible combination of variations. Moreover, users may use the AI/ML models 240 to manage the traffic allocation of the paths of the communication process flow object 215. For example, if the communication process flow object 215 is associated with six different paths (e.g., six different combinations of the action variations), the AI/ML models 240 may manage how many users and which users are sent messages via the respective paths. In some examples, as described elsewhere herein such as with reference to FIG. 4, the AI/ML models 240 may initially route a set of users of the one or more user devices 210 to different paths of the communication process flow object 215 evenly. For example, for a set of six different paths of the communication process flow object 215 and a set of 300 users associated with 300 user devices 210, the server 205 may route subsets of 50 users to each respective path such that each is associated with an equal quantity of users. Routing users via a path may be such that server 205 may transmit electronic communications between an entity to a respective user in accordance with the steps and variations of a respective path of the communication process flow object 215. When transmitting emails via respective path, the server 205 may indicate a communication process flow object path identifier (ID) 250 such that the server 205 can determine which path of the communication process flow object 215 an email is associated with.

Moreover, during the execution of the communication process flow object 215, the AI/ML models 240 may monitor the performance of the one or more paths of the communication process flow object 215. For example, if a user that receives an email via a first path of the communication process flow object 215 opens the email, clicks on a link within the email, or performs one or more actions that satisfies the goal 245 (e.g., the automation event), the server 205 may receive an access indication 255 from the respective user device 210. In some cases, the access indication 255 may also include the communication process flow object path ID 250 such that the server 205 can determine which path the access indication 255 is associated with. Further, a traffic allocation service 260 of the server 205 may use the access indication 255 to allocate the traffic of the users associated with the one or more user devices 210 to the paths of the communication process flow object 215. For example, as described herein, initially, the traffic allocation service 260 may distribute the messages for the set of users of the one or more user devices 210 equally across the paths of the communication process flow object 215. Further, based on monitoring the performance of the paths of the communication process flow object 215, the server 205 may determine (e.g., based on a satisfaction of a goal or automation event), via the AI/ML models 240, that a subset of paths may be relatively more successful and the traffic allocation service 260 may begin to route more users to the subset of paths. Additionally, or alternatively, the server 205 may monitor whether respective paths satisfy the goal 245 or automation event and use the traffic allocation service 260 to distribute electronic communications to users via the paths that satisfy the goal 245 or automation event. For example, the AI/ML models 240 may determine that one or more respective paths of the communication process flow object 215 satisfy a goal satisfaction threshold by satisfying the one or more conditions of the goal 245 a threshold quantity of times. Therefore, the AI/ML models 240 may transmit an indication to the server 205 to indicate that the one or more respective paths have a higher likelihood of satisfying the goal 245 compared to the other paths of the communication process flow object 215. Moreover, it should be understood by one having ordinary skill in the art that an automation event may be associated with the one or more conditions of a goal 245 such that the event (e.g., triggering users to be routed to a flow or triggering an update to the training of the AI/ML models 240) is triggered or executed in response to the goal 245 being satisfied.

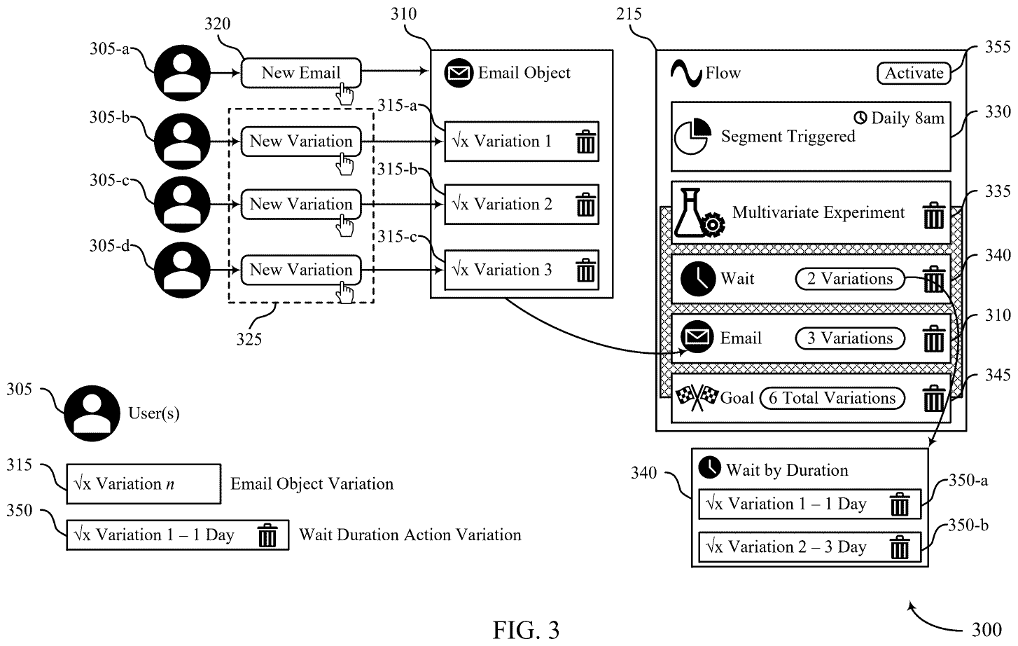

Therefore, the techniques of the present disclosure may enable users to generate one or more goals 245 (e.g., automation events) to more reliably, efficiently, and accurately determine the performance of the paths of the communication process flow object 215. Further, the techniques of the present disclosure may enable the server 205 to distribute communications via the traffic allocation service 260 more accurately based on the AI/ML models 240 monitoring whether the paths of the communication process flow object 215 satisfy the goal 245 of the communication process flow object 215. Further descriptions of the techniques of the present disclosure enabling users to generate goals for the communication process flow object 215 may be described elsewhere herein, such as with reference to FIGS. 3 and 5. Moreover, further descriptions of the techniques of the present disclosure enabling the dynamic distribution of the traffic to the one or more user devices 210 based on one or more conditions of the goal 245 being satisfied may be described elsewhere herein, such as with reference to FIG. 4.

FIG. 3 shows an example of a path variation generation diagram 300 that supports customizable communication process flow path metrics in accordance with aspects of the present disclosure. In some examples, the path variation generation diagram 300 may implement or be implemented by the system 100, the computing system 200, or both. For example, the path variation generation diagram 300 may include one or more users 305 (e.g., a user 305-a, a user 305-b, a user 305-c, a user 305-d, or any combination thereof) which may be operating on cloud client 105 or contact 110 described with reference to FIG. 1.

In some examples, the path variation generation diagram 300 may illustrate one or more users 305 generating an email object 310 and variations of the email object (e.g., an email object variation 315-a, an email object variation 315-b, an email object variation 315-c, or any combination thereof). For example, the user 305-a may generate the email object 310 via a first selection component 320 for generating emails. In some cases, the first selection component 320 may be an example of a button that is selected by the user 305-a to generate the email object 310. Following the generation of the email object 310, one or more users 305 (e.g., the user 305-b, the user 305-c, the user 305-d, or any combination thereof) may generate one or more email object variations 315. In some cases, the one or more users 305 may be examples of email designers or marketing employees of an organization that are responsible for designing an email for a marketing campaign. While designing the email, the one or more users 305 may determine to test different variations of the email, and thus may generate the one or more email object variations 315 as illustrated in the path variation generation diagram 300. For example, the one or more users 305 may generate a set of subject lines for an email and thus may generate the one or more email object variations 315 to test the different subject lines. Further, the one or more users 305 may generate the one or more email object variations 315 via a second selection component 325. In some cases, the second selection component 325 may also be an example of a button that is selected by the one or more users 305 to generate the one or more email object variations 315. Additionally, or alternatively, the first selection component 320 and the second selection component 325 may be displayed to the one or more users 305 within a first user interface of the server 205, a cloud client 105, a contact 110, or any combination thereof.

Further, within the first user interface, a user of the one or more users 305 may be capable of viewing and editing a communication process flow object 215 as described with reference to FIG. 2. In some examples, the email object 310 may be an example of an action or element of the communication process flow object 215. The communication process flow object 215 may also include one or more additional actions or elements such as a segment trigger action 330, a multivariate experiment action 335, a wait duration action 340, a goal action 345, or any combination thereof. In some examples, the segment trigger action 330 may indicate a time or condition for the communication process flow object 215 to trigger. For example, if the communication process flow object 215 controls the transmission of emails between an entity and a set of users, the segment trigger action 330 may indicate a time or condition for the transmission of the emails. In some cases, a user (e.g., one of the one or more users 305) may configure the segment trigger action 330 to be such that the emails are transmitted at a given time of day. For example, as illustrated in FIG. 3, a user may configure the segment trigger action 330 to indicate that the emails should be transmitted at 8 am daily. Additionally, or alternatively, a user may further configure the segment trigger action 330 with a time zone relative to the user or relative to a respective user receiving an email. That is, each user receiving an email from a respective path of the communication process flow object 215 may receive the email at the same time regardless of location, or each respective user may receive the email at 8 am local time based on a respective location of a respective user.

In some other cases, a user may configure the segment trigger action 330 to be based on an action or trigger. For example, if the communication process flow object 215 is transmitting emails related to an electronic commerce (e-commerce) website to attempt to get users to purchase goods from the e-commerce website, a user may configure the segment trigger action 330 to be based on a discount being applied to one or more items or goods on the e-commerce website. That is, the communication process flow object 215 may transmit emails to users based on a discount or reduction in price being applied to one or more items being sold on the e-commerce website. In another example, a user may configure the segment trigger action 330 to trigger the transmission of an email based on a user creating an account on the e-commerce website. For example, when a user creates an account on the e-commerce website, the e-commerce merchant may transmit an email to the user with a coupon or voucher for a one time reduction of price in one or more items.

Further, in addition to the segment trigger action 330, a user may generate a multivariate experiment action 335 for the communication process flow object 215. In some examples, the multivariate experiment action 335 may define an experiment to be tested using the different paths of the communication process flow object 215. For example, a user may configure the multivariate experiment action 335 to test the respective paths of the communication process flow object 215 for a duration to determine which path provides relatively better results. Additionally, or alternatively, the multivariate experiment action 335 may be managed by an AI/ML model. That is, a user may use an AI/ML model to monitor the results of the paths of the communication process flow object 215 based on a configuration of the multivariate experiment action 335. Further, in some examples, the user may configure the multivariate experiment action 335 with a threshold for the AI/ML model to use in determining the performance of a respective path of the communication process flow object 215. For example, the user may configure the multivariate experiment action 335 with a performance metric threshold such that the AI/ML model may determine in a respective path of the communication process flow object 215 satisfies (e.g., meets or exceeds) the performance metric threshold. In some cases, the performance metric threshold may be an example of a goal action 345 satisfaction threshold that is based on a quantity of times a goal is satisfied by a respective path. Moreover, in some examples, the performance metric threshold may be a percentage threshold. For example, a user may configure the performance metric threshold as a 70% satisfaction threshold such that the AI/ML model determines a respective path as successful if at least 70% of the users receiving a respective variation of the one or more email object variations 315 may satisfy the goal action 345. Further descriptions of the multivariate experiment action 335 may be described elsewhere herein, such as with reference to FIG. 4.

Further, a user may also configure the communication process flow object 215 with the wait duration action 340. The wait duration action 340 may indicate a duration of (e.g., hours, days, weeks, months, or any combination thereof) that the communication process flow object 215 should wait before sending a follow up email to a user. In some examples, the user may configure the wait duration action 340 with one or more wait duration action variations 350 (e.g., a wait duration action 350-a, a wait duration action 350-b, or both). In some cases, the wait duration action 350-a may indicate that the communication process flow object 215 should wait one day before transmitting a follow-up email and the wait duration action 350-b may indicate that the communication process flow object 215 should wait 3 days before transmitting the follow-up email. Therefore, the respective paths of the communication process flow object 215 may include different variations of the one or more wait duration action variations 350 to test each combination of the one or more wait duration action variations 350 and the one or more other actions of the communication process flow object 215. For example, a first path may include an initial transmission of the email object variation 315-a and then may use the wait duration action 350-a to determine when to transmit a follow-up email. Further, a second path may include the initial transmission of the email object variation 315-a and then may use the wait duration action 350-b to determine the follow-up email transmission time. Therefore, the communication process flow object 215 may include a set of paths that indicate each possible combination of the actions and action variations of the communication process flow object 215.

Further, in accordance with the techniques of the present disclosure, a user may configure the communication process flow object 215 with the goal action 345. The goal action 345 may be used such that the AI/ML model is capable of determining the success of a respective path of the communication process flow object 215. For example, the goal action 345 may indicate a condition of a user purchasing a defined item based on interacting with the email transmitted from the communication process flow object 215 that can trigger an automation event. In some cases, the AI/ML model may analyze a set of data from a data platform external to the communication process flow object 215 to determine if a condition of an automation event or the goal action 345 is satisfied. Further, in some examples, the user may configure one or more variations for the goal action 345. Further descriptions of the goal action 345 and the configuration of the goal action may be described elsewhere herein, such as with reference to FIG. 5.

Additionally, or alternatively, as illustrated by the shaded box behind the multivariate experiment action 335, the wait duration action 340, the email object 310, and the goal action 345 may indicate that such actions are managed via the AI/ML model. For example, as described elsewhere herein, the AI/ML model may use the multiple variations of the email object 310, the wait duration action 340, the goal action 345, or any combination thereof, to generate a set of paths for the communication process flow object 215 to be used for the multivariate experiment action 335. Further, the AI/ML model may manage and determine the traffic allocation for the set of paths based on the configuration of the multivariate experiment action 335.

Therefore, once a user completes the configuration of the communication process flow object 215 with the one or more actions of the communication process flow object 215, the user may select a third selection component 355 to activate the communication process flow object 215. In some examples, the third selection component 355 may be an example of a button that a user can select to activate the communication process flow object 215. Further descriptions of the activation of the communication process flow object 215 and the testing of the set of paths of the communication process flow object 215 in accordance with the configurations of the one or more actions of the communication process flow object 215 may be described elsewhere herein, such as with reference to FIG. 4.

FIG. 4 shows an example of a path variation testing diagram 400 that supports customizable communication process flow path metrics in accordance with aspects of the present disclosure. In some examples, the path variation testing diagram 400 may implement or be implemented by the system 100, the computing system 200, the path variation generation diagram 300, or any combination thereof. For example, the path variation testing diagram 400 may include a communication process flow object 215 as described with reference to FIG. 2 which may be configured and activated via an activation selection component 405 (e.g., a button) by a user operating on a cloud client 105 or a contact 110 described with reference to FIG. 1.

As described with reference to FIG. 3, a user may configure the communication process flow object 215 with one or more actions to control the electronic communications (e.g., email transmissions) between an entity (e.g., an organization) and a set of users. Further, an AI/ML model may be used to generate a set of paths of each possible combination of actions and action variations of the communication process flow object 215 such that a user may conduct an accurate test of the action variations of the communication process flow object 215. For example, as illustrated, if there are two wait duration action variations, three email object variations, and six goal action variations (e.g., automation event variations), the AI/ML model may generate a total of 36 paths for the communication process flow object 215. That is, a quantity of paths that are independent from each other may be equivalent to a product of the quantity of variations for each action that is associated with two or more variations. Therefore, since there are two wait duration action variations, three email object variations, and six goal action variations, the total quantity of paths may be determined as a product of two, three, and six (e.g., 2*3*6). Further, it should be understood that such actions, actions with variations, and variation quantities may be examples and the communication process flow object 215 may include additional actions, different actions may be associated with variations, and different quantities of variations for a respective action.

Therefore, as the quantity of variations for actions increases, the quantity of actions with two or more variations increases, or both, the quantity of paths may drastically increase accordingly. For example, if a user adds an additional wait duration action variation for a total of three wait duration action variations, the total quantity of paths may increase from 36 to 54. In another example, if the user adds two variations for a segment trigger action (e.g., the segment trigger action 330 described with reference to FIG. 3), the total quantity of paths may increase from 36 to 72. Moreover, if the user both adds an additional wait duration action variation and adds two variations for the segment trigger action, the total quantity of paths may increase from 36 to 108. Therefore, having the AI/ML model generate and manage the respective paths for the communication process flow object 215 may be relatively time-efficient and provide for an increase in accuracy as the likelihood of a user generating a relatively large quantity of paths (e.g., more than 2 or 3 paths) may be relatively low. Further, as described elsewhere herein, the techniques of the present disclosure may describe enhancements to a server (e.g., the server 205 described with reference to FIG. 2) to enable the user the capability of generating one or more goals for the communication process flow object 215 to determine the success of the respective paths of the communication process flow object 215.

Thus, once the user has completed the configuration of the communication process flow object 215 and the AI/ML model has generated the set of paths of the communication process flow object 215, the user may select the activation selection component 405 to activate the communication process flow object 215. In some examples, the activation of the communication process flow object 215 via the activation selection component 405 may include an initiation of a multivariate experiment 410 of the communication process flow object 215 (e.g., the multivariate experiment action 335 described with reference to FIG. 3). In some cases, the multivariate experiment 410 may indicate the set of parameters for an AI/ML model to use when performing the multivariate experiment 410. For example, the multivariate experiment 410 may indicate a duration parameter that indicates a duration for the multivariate experiment 410. As illustrated herein, the multivariate experiment 410 may have a duration of 30 days.

In some examples, the configuration of the multivariate experiment 410 may also indicate an initial variation traffic distribution 415. The initial variation traffic distribution 415 may indicate how the communication process flow object 215 may distribute the traffic across the two or more paths or variations 420 of the communication process flow object 215. For example, as illustrated herein, the initial variation traffic distribution 415 may distribute the traffic evenly across the variations 420 of the communication process flow object 215. Further, it should be understood that the paths of the communication process flow object 215 may also be referred to as variations 420 elsewhere herein.

Therefore, the communication process flow object 215 may transmit one or more emails to a set of users in accordance with the set of users being evenly distributed across the variations 420 of the communication process flow object 215. During the execution of the communication process flow object 215, the AI/ML model may monitor the performance of each respective variation 420 and dynamically adjust the distribution of traffic. For example, the AI/ML model may determine that a first variation is performing relatively better than a second variation based on the results of the first variation satisfying a goal of the communication process flow object 215 with a relatively higher frequency. That is, the data stored within the data platform that is generated as a result of the first variation and corresponding path of the communication process flow object 215 may satisfy the goal for the communication process flow object 215 at a relatively higher rate than the data generated as a result of the second variation and corresponding path of the communication process flow object 215. Therefore, the server associated with the communication process flow object 215 may increase the quantity of users being routed to a path associated with the first variation rather and decrease the quantity of users being routed to a path associated with the second variation. Further, during the execution, a user may observe the current distribution metrics via a metrics panel of a user interface (e.g., the first user interface used to generate the communication process flow object 215 or a separate second user interface).

Once the duration for the multivariate experiment 410 expires (e.g., after the has been executed for 30 days), a user may receive a notification to review and analyze the results. In some cases, the results may be displayed via a final variation traffic distribution 425 to illustrate the traffic distribution across the variations 420 after the execution of the multivariate experiment 410. In some examples, the final variation traffic distribution 425 may indicate that one or more paths associated with one or more variations 420 may be relatively more successful than the others. For example, the final variation traffic distribution 425 may indicate that a variation 420-a is relatively successful as the AI/ML model determined to route 75% of the set of users to the path associated with the variation 420-a. Further, a variation 420-b may also be relatively successful as the AI/ML model determined to route the remaining 25% of the set of users to the path associated with the variation 420-b rather than any of the remaining paths associated with the remaining variations 420. Therefore, the final variation traffic distribution 425 may indicate that the variation 420-a and the variation 420-b may be relatively efficient in satisfying the goal of the communication process flow object 215.

In some examples, while analyzing the data, a user may select the variation 420-a for all subsequent communications. In some other examples, the user may determine to continue the multivariate experiment 410 for a second duration. In some cases, the second duration may be the same, longer, or shorter than the initial duration for the multivariate experiment 410. Additionally, or alternatively, the user may determine to edit the action variations of the communication process flow object 215 to enable the AI/ML model in generating variations 420 and associated paths similar to the variation 420-a and the variation 420-b. Therefore, the user may reactivate the communication process flow object 215 via the activation selection component 405 to rerun the multivariate experiment 410. In another example, the user may enable the AI/ML model to generate one or more similar variations and corresponding paths based on the variation 420-a and the variation 420-b. For example, the AI/ML model may use generative AI techniques to generate additional action variations, replace action variations, or both, to generate variations 420 of the communication process flow object 215 that are similar to the variation 420-a, the variation 420-b, or both.

Therefore, in accordance with the techniques of the present disclosure, users may configure and use AI/ML models to autonomously route users to different paths of the communication process flow object 215 based on whether a respective path satisfies the goal or automation event of the communication process flow object 215. Further, the AI/ML models may be capable of learning both which paths (e.g., which combinations of action variations) result in an increase in performance (e.g., an increase in satisfaction of the goal or condition for an automation event) and which action variations result in an increase in performance. For example, if a communication process flow object 215 is associated with a relatively large quantity of actions and each action is associated with a relatively large quantity of variations, the quantity of data from the execution of the communication process flow object 215 may be relatively large. Therefore, in accordance with the techniques of the present disclosure, an AI/ML model may analyze the data to determine which paths result in an increase in performance. Based on the path performance, the AI/ML model may be capable of determining one or more performance metrics of individual action variations. For example, if each path associated with a first variation of an email results in an increase in performance compared to a second variation of the email, the AI/ML model may begin to route users to paths associated with the first variation of the email over paths associated with the second variation of the email.

Further, the techniques of the present disclosure may enable the AI/ML model to use data stored in the data platform that is separate from the communication process flow object 215 and from the one or more actions of the communication process flow object 215 to determine a successful path. Moreover, in some cases, the data stored in the data platform from the one or more actions may be stored in different formats that are incompatible with each other. For example, a first set of data stored within the data platform may be related to the performance of a first email object variation that is in a first data format and a second set of data stored within the data platform may be related to the performance of a first wait duration action variation that is in a second data format. Therefore, the AI/ML model may be used to analyze the first set of data and the second set of data that are in different data to determine both action specific performance metrics and path specific performance metrics. For example, the AI/ML model may generate a third set of data from the first set of data and the second set of data to be within a third data format that is associated with both the first email object variation and the first wait duration action variation. Thus, the techniques of the present disclosure may enable an AI/ML model to analyze different sets of data for a respective path that is stored within the data platform to determine the performance metric of a respective path of the communication process flow object 215. Further, these techniques may reduce communication resource overhead, as users are dynamically routed to paths based on path performance, communication resources may not be used on lower performing paths. Further descriptions of the AI/ML model being used in accordance with the techniques of the present disclosure may described elsewhere herein, such as with reference to FIG. 5.

FIG. 5 shows an example of a user interface 500 that supports customizable communication process flow path metrics in accordance with aspects of the present disclosure. In some examples, the user interface 500 may implement or be implemented by the system 100, the computing system 200, the path variation generation diagram 300, the path variation testing diagram 400, or any combination thereof. For example, a user may use the user interface 500 while operating on a cloud client 105 or a contact 110 described with reference to FIG. 1. Further, the user interface 500 may be an example of a user interface associated with a computing device such as a user device (e.g., the one or more user devices 210) or a server (e.g., the server 205) as described with reference to FIG. 2.

In some examples, a user may use the user interface 500 to configure a communication process flow object with one or more goals (e.g., automation events) for determining whether a respective path of the communication process flow object is successful and whether relatively more users should be routed to the respective path. Further, the one or more goals may be based on data stored within a data platform that is separate from the communication process flow object. In some examples, the data platform may be an example of a data storage system that includes one or more data resources from one or more different sources (e.g., different services, merchants, tenants of a multi-tenant system). Further, in some cases, the data platform may be represented as a cloud-based data platform, a database, a multi-tenant database system, or any combination thereof. Therefore, a user may be capable of selecting data from one or more resources to configure the goal of the communication process flow.

In some examples, to configure the goal (e.g., automation event) within the user interface 500, a user may use a conditional value field 505 to select a first conditional value. In some cases, the conditional value field 505 may be an example of a drop-down field as illustrated by the upside triangle. That is, the user may select the conditional value field 505 and may be displayed one or more conditional value options to select from. As illustrated herein, a user may select that the conditional value of the conditional value field 505 be such that all conditions should be met. That is, each conditional value within the configuration of the goal within the user interface 500 should be evaluated as true.

Further, the user may select a first resource within a resource selection field 510 to access data from to determine the satisfaction of the goal (e.g., automation event). Moreover, the user may also configure the conditions for the selected resource. For example, the user may configure the goal such that the goal or automation event is capable of being satisfied if a measurement of the resource satisfies a value in view of an operator. Therefore, as illustrated herein, a user may select a sales order product resource and select the measurement of the resource to be counted, the operator to be ‘at least,’ and the value to be one. That is, there should be at least one item in the count of the sales order product resource an ability to satisfy the goal. For example, if the resource is a database, there should be at least one item within the database. Moreover, the database is empty, and thus a lack of sales, the goal may be unable to be satisfied until there is at least one sale stored within the sales order product resource.

In addition to the selection of the resource, the user may select a conditional value for a conditional value field 515 that is based on the selected resource within the resource selection field 510. As illustrated herein, the user may select, from the drop-down of the conditional value field 515, that the goal (e.g., automation event) is capable of being satisfied based on one or more additional aspects. Moreover, a user may select a field of a resource within a resource field selection field 520 whose value be satisfied in view of an operator. For example, as illustrated herein, the user may select that a goal may be satisfied based on data associated with a sales order product category being equal to shoes. That is, the goal of the communication process flow object may be based on a purchase of shoes within the sales order product resource.

Further, the user may select a conditional value for a conditional value field 525 to determine a Boolean operator for one or more conditions of the goal (e.g., automation event). For example, as illustrated herein, the user may select, from a drop down, an ‘OR’ conditional value such that the goal of a communication process flow object being satisfied is based on at least one condition of the goal being satisfied. Therefore, the user may also configure one or more conditions 530 for the goal. In some examples, the user may generate a single condition 530 or multiple conditions 530 for the goal to be satisfied. As illustrated herein, the user may generate a first condition that is based on a respective entry of a color subfield of the sales order product resource being equal to red and a second condition based on the color subfield of the sales order product resource being equal to blue. That is, the goal for the communication process flow object may be satisfied if a user purchases red or blue shoes in response to receiving an electronic communication from a respective path of the communication process flow object.

Therefore, in such examples, a respective path of the communication process flow object may satisfy the goal of the communication process flow object based on whether the users routed to the respective path purchase red or blue shoes in response to receiving one or more emails from an entity associated with the communication process flow object. Further, the user may also select an add condition selection component 535 of the user interface 500 to add additional conditions that could satisfy the goal. For example, the user may select to add a condition that indicates a user spending $100 or greater could satisfy the goal. Moreover, in some examples, the user may select the goal to be based on two or more resources. For example, the user may be capable of selecting a second resource that stores data related to web traffic. In such examples, the user can select that the goal be satisfied if the user visited the website of the e-commerce merchant that initiated the communication process flow object at least twice and purchased red or blue shoes. Additionally, or alternatively, a user may configure a goal or a goal condition 530 as an exit condition such that once satisfied a user may be removed from receiving emails from a path of communication process flow object. For example, once a user purchases a pair of red shoes, the e-commerce website may refrain from transmitting additional emails to the user trying to convince the user to buy red or blue shoes. Further, in some cases, if a user satisfies an exit condition, the user may be added to a list of users that have satisfied the exit condition which can be used for a subsequent communication process flow object with different goals and conditions 530.

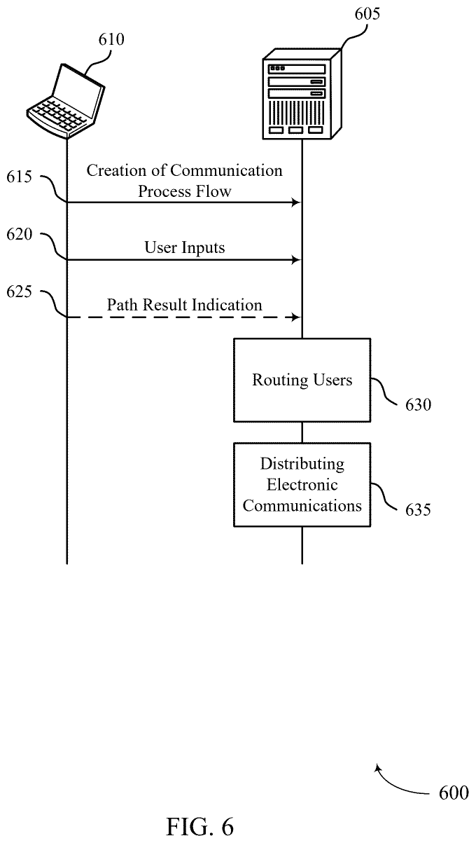

Thus, the techniques of the present disclosure enabling the capability for users to generate goals for a communication process flow object for the paths of the communication process flow object to be considered successful paths may increase the effectiveness and reliability of the communication process flow object. For example, the user may be capable of determining whether a respective subject line, hero image, wait duration, follow-up email subject line, or any combination thereof can result in an increase in sales for an organization. Moreover, as a goal may implement or may be implemented by an automation event, an AI/ML model may determine to route users or enhance training of the AI/ML models based on satisfaction of the goal that triggers the automation event. For example, the event associated with the automation event may be to change one or more weights in the training data of the AI/ML models or to trigger traffic allocations to or away from one or more respective paths of a communication process flow object. Further descriptions of the techniques of the present disclosure enabling users to generate goals and an AI/ML model being used to dynamically allocate traffic based on one or more paths of a communication process flow object being satisfied may be described elsewhere herein, such as with reference to FIG. 6.

FIG. 6 shows an example of a process flow 600 that supports customizable communication process flow path metrics in accordance with aspects of the present disclosure. In some examples, the process flow 600 may implement or may be implemented by the system 100, the computing system 200, the path variation generation diagram 300, the path variation testing diagram 400, the user interface 500, or any combination thereof. The process flow 600 may include a server 605 and a computing device 610 which may be examples of devices or services described elsewhere herein including with reference to FIGS. 1 and 2. For example, the server 605 and the computing device 610 may be examples of a cloud client 105, a contact 110, or both, as described with reference to FIG. 1.

In the following description of the process flow 600, the operations may be performed by the server 605 and the computing device 610 in different orders or at different times. Some operations may also be left out of the process flow 600, or other operations may be added. Although the process flow 600 may be described as being performed by the server 605 and the computing device 610, some aspects of some operations may also be performed by other devices, services, or models described elsewhere herein including with reference to FIGS. 1 and 2.

At 615, the computing device 610 may transmit, to the server 605, an indication of a creation of a communication process flow including a set of actions that control electronic communications between an entity and a set of users. Further, the communication process flow may include a set of paths for the set of actions. In some examples, the creation of a communication process flow may include the server 605 receiving, from the computing device 610 and prior to receiving the first user input, one or more second user inputs that indicates at least two first action variations of a first action of the set of actions and at least two second action variations of a second action of the set of actions. Moreover, the communication process flow may include the set of paths based on receiving the one or more second user inputs, where the set of paths are for a set of combinations of the at least two first action variations and the at least two second action variations.

At 620, the computing device 610 may transmit, to the server 605, a first user input that indicates a goal for the set of paths of the communication process flow may be received. The goal may be based on data stored within a data platform that is separate from the communication process flow. Additionally, or alternatively, the computing device 610 may transmit, to the server 605, one or more first user inputs that indicate two or more goals for the set of paths of the communication process flow. Further, the two or more goals may include the goal indicated via the first user input. In some examples, the computing device 610, the server 605, or both may assign respective weight indications to the two or more goals. Moreover, in some cases, the computing device 610 may transmit, to the server 605, an indication of one or more data records of a set of data records stored within the data platform, an indication of one or more data record fields of the one or more data records, an indication of one or more goal conditions that are based on one or more values of the one or more data record fields, or any combination thereof may also be received.

In some cases, at 625, the computing device 610, the server 605, or both, may transmit or receive an indication that the result of the one or more paths has a higher likelihood of satisfying the goal relative to a remaining one or more paths of the set of paths of the communication process flow. Therefore, routing a subset of the set of users via the one or more paths may be based on receiving the indication.

Additionally, or alternatively, the server 605 may transmit, to a ML model (e.g., an AI/ML model), a first indication of the goal and that the result of the one or more paths satisfy the goal. The server 605 may then receive, from the ML model, a second indication of a second goal for the set of paths of the communication process flow that is different from the goal. In some examples, the second goal may be based on the data stored within the data platform. Therefore, the subset of the set of users may be routed via the one or more paths of the set of paths based on the result of the one or more paths satisfying the goal for the set of paths, the second goal for the set of paths, or both.

At 630, at least a subset of the set of users may be routed via one or more paths of the set of paths based on a result of the one or more paths satisfying the goal for the set of paths of the communication process flow. The subset may be routed based on data within the data platform for one or more prior users subject to the communication process flow satisfying one or more conditions of the goal. In some cases, the goal may be specified as a Boolean expression and operands of the Boolean expression may include data stored within the data platform that is separate from the communication process flow, where the result satisfies the Boolean expression. At 635, a subset of the electronic communications may be distributed to the subset of the set of users in accordance with the one or more paths. Further, in some examples, a set of analytics corresponding to data associated with the result of the one or more paths satisfying the goal may be displayed via a first user interface.

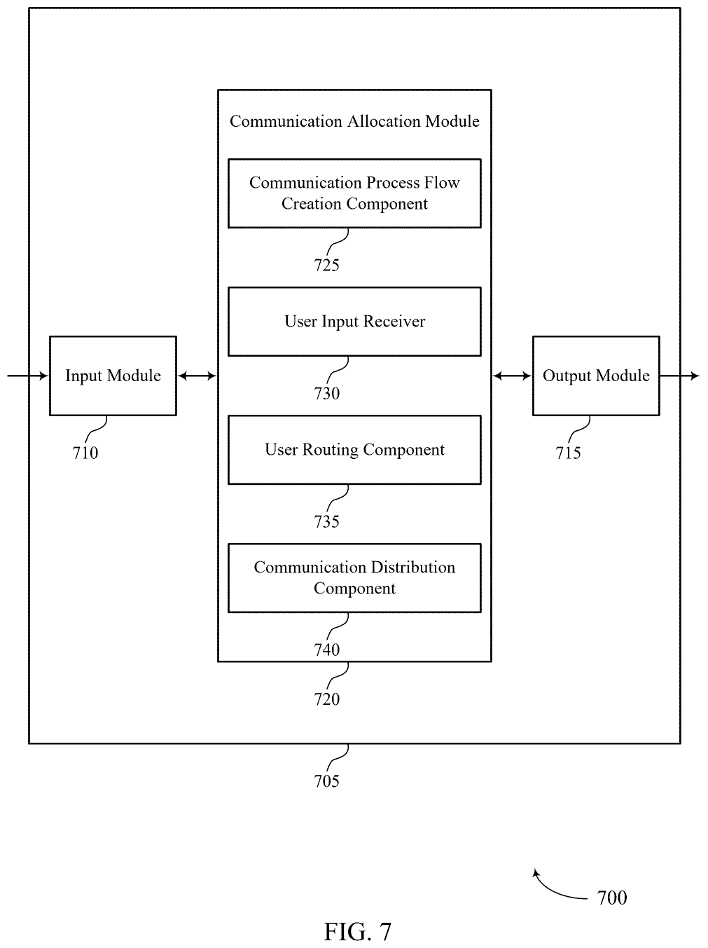

FIG. 7 shows a block diagram 700 of a device 705 that supports customizable communication process flow path metrics in accordance with aspects of the present disclosure. The device 705 may include an input module 710, an output module 715, and a communication allocation module 720. The device 705, or one or more components of the device 705 (e.g., the input module 710, the output module 715, the communication allocation module 720), may include at least one processor, which may be coupled with at least one memory, to support the described techniques. Each of these components may be in communication with one another (e.g., via one or more buses).

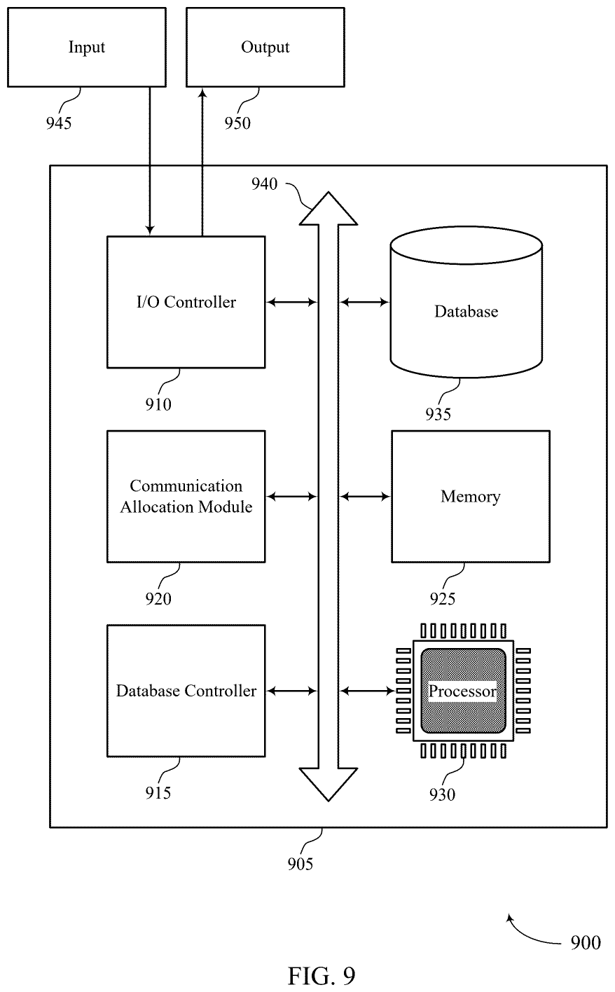

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the communication allocation module 720 to support customizable communication process flow path metrics. In some cases, the input module 710 may be a component of an input/output (I/O) controller 910 as described with reference to FIG. 9.

The output module 715 may manage output signals for the device 705. For example, the output module 715 may receive signals from other components of the device 705, such as the communication allocation module 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the communication allocation module 720 may include a communication process flow creation component 725, a user input receiver 730, a user routing component 735, a communication distribution component 740, or any combination thereof. In some examples, the communication allocation module 720, or various components thereof, may be configured to perform various operations (e.g., receiving, monitoring, transmitting) using or otherwise in cooperation with the input module 710, the output module 715, or both. For example, the communication allocation module 720 may receive information from the input module 710, send information to the output module 715, or be integrated in combination with the input module 710, the output module 715, or both to receive information, transmit information, or perform various other operations as described herein.

The communication allocation module 720 may support data processing in accordance with examples as disclosed herein. The communication process flow creation component 725 may be configured to support receiving an indication of a creation of a communication process flow including a set of multiple actions that control electronic communications between an entity and a set of multiple users, the communication process flow including a set of multiple paths for the set of multiple actions. The user input receiver 730 may be configured to support receiving a first user input that indicates a goal for the set of multiple paths of the communication process flow, the goal being based on data stored within a data platform that is separate from the communication process flow. The user routing component 735 may be configured to support routing at least a subset of the set of multiple users via one or more paths of the set of multiple paths based on a result of the one or more paths satisfying the goal for the set of multiple paths of the communication process flow. The communication distribution component 740 may be configured to support distributing a subset of the electronic communications to the subset of the set of multiple users in accordance with the one or more paths.

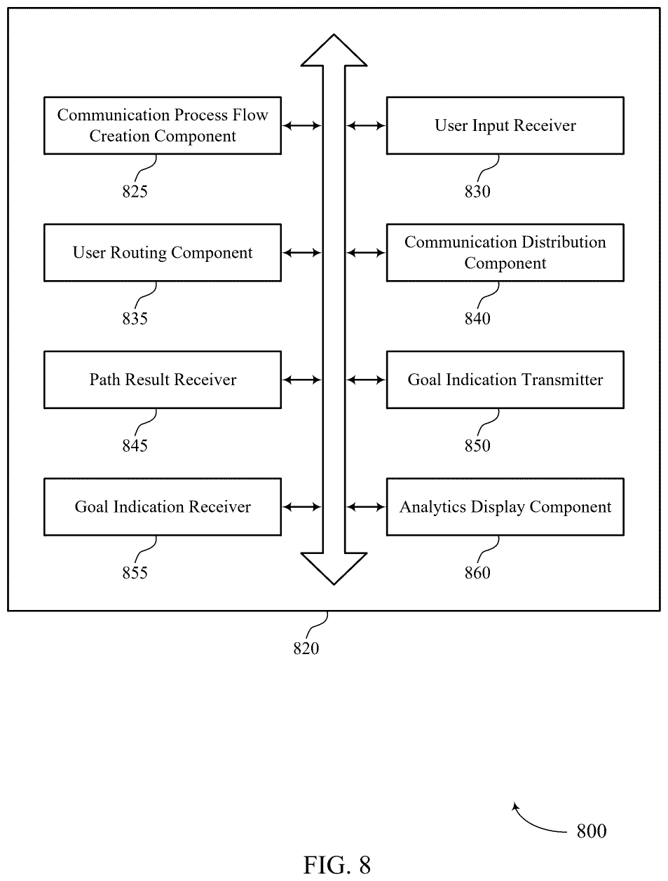

FIG. 8 shows a block diagram 800 of a communication allocation module 820 that supports customizable communication process flow path metrics in accordance with aspects of the present disclosure. The communication allocation module 820 may be an example of aspects of a communication allocation module or a communication allocation module 720, or both, as described herein. The communication allocation module 820, or various components thereof, may be an example of means for performing various aspects of customizable communication process flow path metrics as described herein. For example, the communication allocation module 820 may include a communication process flow creation component 825, a user input receiver 830, a user routing component 835, a communication distribution component 840, a path result receiver 845, a goal indication transmitter 850, a goal indication receiver 855, an analytics display component 860, or any combination thereof. Each of these components, or components of subcomponents thereof (e.g., one or more processors, one or more memories), may communicate, directly or indirectly, with one another (e.g., via one or more buses).

The communication allocation module 820 may support data processing in accordance with examples as disclosed herein. The communication process flow creation component 825 may be configured to support receiving an indication of a creation of a communication process flow including a set of multiple actions that control electronic communications between an entity and a set of multiple users, the communication process flow including a set of multiple paths for the set of multiple actions. The user input receiver 830 may be configured to support receiving a first user input that indicates a goal for the set of multiple paths of the communication process flow, the goal being based on data stored within a data platform that is separate from the communication process flow. The user routing component 835 may be configured to support routing at least a subset of the set of multiple users via one or more paths of the set of multiple paths based on a result of the one or more paths satisfying the goal for the set of multiple paths of the communication process flow. The communication distribution component 840 may be configured to support distributing a subset of the electronic communications to the subset of the set of multiple users in accordance with the one or more paths.

In some examples, the path result receiver 845 may be configured to support receiving an indication that the result of the one or more paths has a higher likelihood of satisfying the goal relative to a remaining one or more paths of the set of multiple paths of the communication process flow, where routing the subset of the set of multiple users via the one or more paths is based on receiving the indication.

In some examples, to support receiving the first user input that indicates the goal for the set of multiple paths, the user input receiver 830 may be configured to support receiving one or more first user inputs that indicate two or more goals for the set of multiple paths of the communication process flow, the two or more goals including the goal.

In some examples, to support receiving the one or more first user inputs, the user input receiver 830 may be configured to support receiving respective weight indications for the two or more goals, where each goal of the two or more goals is assigned respective weight.

In some examples, the goal indication transmitter 850 may be configured to support transmitting, to a machine learning model, a first indication of the goal and that the result of the one or more paths satisfy the goal. In some examples, the goal indication receiver 855 may be configured to support receiving, from the machine learning model, a second indication of a second goal for the set of multiple paths of the communication process flow that is different from the goal based on transmitting the first indication to the machine learning model, the second goal being based on the data stored within the data platform, where the subset of the set of multiple users are routed via the one or more paths of the set of multiple paths based on the result of the one or more paths satisfying the goal for the set of multiple paths, the second goal for the set of multiple paths, or both.

In some examples, to support routing at least a subset of the set of multiple users, the user routing component 835 may be configured to support routing the subset based on data within the data platform for one or more prior users subject to the communication process flow satisfying one or more conditions of the goal.

In some examples, the goal is specified as a Boolean expression and operands of the Boolean expression include data stored within the data platform that is separate from the communication process flow, where the result satisfies the Boolean expression.

In some examples, the analytics display component 860 may be configured to support displaying, via a first user interface, a set of analytics corresponding to data associated with the result of the one or more paths satisfying the goal.

In some examples, to support receiving the first user input that indicates the goal for the set of multiple paths, the user input receiver 830 may be configured to support receiving, via a first user interface, an indication of a one or more data records of a set of multiple data records stored within the data platform, an indication of one or more data record fields of the one or more data records, an indication of one or more goal conditions that are based on one or more values of the one or more data record fields, or any combination thereof.

In some examples, to support creation of a communication process flow, the communication process flow creation component 825 may be configured to support receiving, prior to receiving the first user input, one or more second user inputs that indicates at least two first action variations of a first action of the set of multiple actions and at least two second action variations of a second action of the set of multiple actions, the communication process flow including the set of multiple paths based on receiving the one or more second user inputs, where the set of multiple paths are for a set of multiple combinations of the at least two first action variations and the at least two second action variations.

FIG. 9 shows a diagram of a system 900 including a device 905 that supports customizable communication process flow path metrics in accordance with aspects of the present disclosure. The device 905 may be an example of or include components of a device 705 as described herein. The device 905 may include components for bi-directional data communications including components for transmitting and receiving communications, such as a communication allocation module 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting customizable communication process flow path metrics). The processor 930 may be an example of a single processor or multiple processors. For example, the device 905 may include one or more processors 930.

The communication allocation module 920 may support data processing in accordance with examples as disclosed herein. For example, the communication allocation module 920 may be configured to support receiving an indication of a creation of a communication process flow including a set of multiple actions that control electronic communications between an entity and a set of multiple users, the communication process flow including a set of multiple paths for the set of multiple actions. The communication allocation module 920 may be configured to support receiving a first user input that indicates a goal for the set of multiple paths of the communication process flow, the goal being based on data stored within a data platform that is separate from the communication process flow. The communication allocation module 920 may be configured to support routing at least a subset of the set of multiple users via one or more paths of the set of multiple paths based on a result of the one or more paths satisfying the goal for the set of multiple paths of the communication process flow. The communication allocation module 920 may be configured to support distributing a subset of the electronic communications to the subset of the set of multiple users in accordance with the one or more paths.

By including or configuring the communication allocation module 920 in accordance with examples as described herein, the device 905 may support techniques for a user generating goals for a communication process flow to determine, via AI and ML models, whether path variations of the communication process flow are successful to support improved communication reliability, improved user experience related to the improved communication reliability, more efficient utilization of communication resources, and an increase in efficiency of a communication process flow.

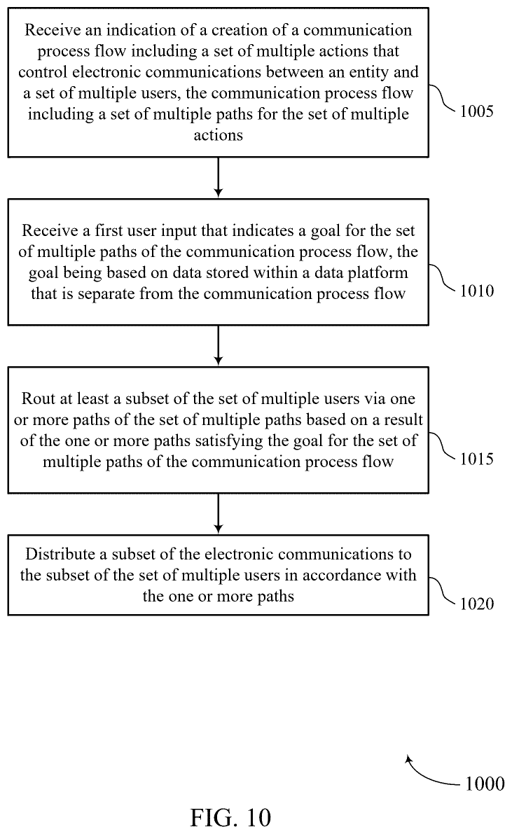

FIG. 10 shows a flowchart illustrating a method 1000 that supports customizable communication process flow path metrics in accordance with aspects of the present disclosure. The operations of the method 1000 may be implemented by a computing device or its components as described herein. For example, the operations of the method 1000 may be performed by a computing device as described with reference to FIGS. 1 through 9. In some examples, a computing device may execute a set of instructions to control the functional elements of the computing device to perform the described functions. Additionally, or alternatively, the computing device may perform aspects of the described functions using special-purpose hardware.

At 1005, the method may include receiving an indication of a creation of a communication process flow including a set of multiple actions that control electronic communications between an entity and a set of multiple users, the communication process flow including a set of multiple paths for the set of multiple actions. The operations of 1005 may be performed in accordance with examples as disclosed herein. In some examples, aspects of the operations of 1005 may be performed by a communication process flow creation component 825 as described with reference to FIG. 8.

At 1010, the method may include receiving a first user input that indicates a goal for the set of multiple paths of the communication process flow, the goal being based on data stored within a data platform that is separate from the communication process flow. The operations of 1010 may be performed in accordance with examples as disclosed herein. In some examples, aspects of the operations of 1010 may be performed by a user input receiver 830 as described with reference to FIG. 8.

At 1015, the method may include routing at least a subset of the set of multiple users via one or more paths of the set of multiple paths based on a result of the one or more paths satisfying the goal for the set of multiple paths of the communication process flow. The operations of 1015 may be performed in accordance with examples as disclosed herein. In some examples, aspects of the operations of 1015 may be performed by a user routing component 835 as described with reference to FIG. 8.

At 1020, the method may include distributing a subset of the electronic communications to the subset of the set of multiple users in accordance with the one or more paths. The operations of 1020 may be performed in accordance with examples as disclosed herein. In some examples, aspects of the operations of 1020 may be performed by a communication distribution component 840 as described with reference to FIG. 8.

A method for data processing by an apparatus is described. The method may include receiving an indication of a creation of a communication process flow including a set of multiple actions that control electronic communications between an entity and a set of multiple users, the communication process flow including a set of multiple paths for the set of multiple actions, receiving a first user input that indicates a goal for the set of multiple paths of the communication process flow, the goal being based on data stored within a data platform that is separate from the communication process flow, routing at least a subset of the set of multiple users via one or more paths of the set of multiple paths based on a result of the one or more paths satisfying the goal for the set of multiple paths of the communication process flow, and distributing a subset of the electronic communications to the subset of the set of multiple users in accordance with the one or more paths.

An apparatus for data processing is described. The apparatus may include one or more memories storing processor executable code, and one or more processors coupled with the one or more memories. The one or more processors may individually or collectively be operable to execute the code to cause the apparatus to receive an indication of a creation of a communication process flow including a set of multiple actions that control electronic communications between an entity and a set of multiple users, the communication process flow including a set of multiple paths for the set of multiple actions, receive a first user input that indicates a goal for the set of multiple paths of the communication process flow, the goal being based on data stored within a data platform that is separate from the communication process flow, route at least a subset of the set of multiple users via one or more paths of the set of multiple paths based on a result of the one or more paths satisfying the goal for the set of multiple paths of the communication process flow, and distribute a subset of the electronic communications to the subset of the set of multiple users in accordance with the one or more paths.

Another apparatus for data processing is described. The apparatus may include means for receiving an indication of a creation of a communication process flow including a set of multiple actions that control electronic communications between an entity and a set of multiple users, the communication process flow including a set of multiple paths for the set of multiple actions, means for receiving a first user input that indicates a goal for the set of multiple paths of the communication process flow, the goal being based on data stored within a data platform that is separate from the communication process flow, means for routing at least a subset of the set of multiple users via one or more paths of the set of multiple paths based on a result of the one or more paths satisfying the goal for the set of multiple paths of the communication process flow, and means for distributing a subset of the electronic communications to the subset of the set of multiple users in accordance with the one or more paths.

A non-transitory computer-readable medium storing code for data processing is described. The code may include instructions executable by one or more processors to receive an indication of a creation of a communication process flow including a set of multiple actions that control electronic communications between an entity and a set of multiple users, the communication process flow including a set of multiple paths for the set of multiple actions, receive a first user input that indicates a goal for the set of multiple paths of the communication process flow, the goal being based on data stored within a data platform that is separate from the communication process flow, route at least a subset of the set of multiple users via one or more paths of the set of multiple paths based on a result of the one or more paths satisfying the goal for the set of multiple paths of the communication process flow, and distribute a subset of the electronic communications to the subset of the set of multiple users in accordance with the one or more paths.

Some examples of the method, apparatus, and non-transitory computer-readable medium described herein may further include operations, features, means, or instructions for receiving an indication that the result of the one or more paths may have a higher likelihood of satisfying the goal relative to a remaining one or more paths of the set of multiple paths of the communication process flow, where routing the subset of the set of multiple users via the one or more paths may be based on receiving the indication.

In some examples of the method, apparatus, and non-transitory computer-readable medium described herein, receiving the first user input that indicates the goal for the set of multiple paths may include operations, features, means, or instructions for receiving one or more first user inputs that indicate two or more goals for the set of multiple paths of the communication process flow, the two or more goals including the goal.

In some examples of the method, apparatus, and non-transitory computer-readable medium described herein, receiving the one or more first user inputs may include operations, features, means, or instructions for receiving respective weight indications for the two or more goals, where each goal of the two or more goals may be assigned respective weight.

Some examples of the method, apparatus, and non-transitory computer-readable medium described herein may further include operations, features, means, or instructions for transmitting, to a machine learning model, a first indication of the goal and that the result of the one or more paths satisfy the goal and receiving, from the machine learning model, a second indication of a second goal for the set of multiple paths of the communication process flow that may be different from the goal based on transmitting the first indication to the machine learning model, the second goal being based on the data stored within the data platform, where the subset of the set of multiple users may be routed via the one or more paths of the set of multiple paths based on the result of the one or more paths satisfying the goal for the set of multiple paths, the second goal for the set of multiple paths, or both.

In some examples of the method, apparatus, and non-transitory computer-readable medium described herein, routing at least a subset of the set of multiple users may include operations, features, means, or instructions for routing the subset based on data within the data platform for one or more prior users subject to the communication process flow satisfying one or more conditions of the goal.

In some examples of the method, apparatus, and non-transitory computer-readable medium described herein, the goal may be specified as a Boolean expression and operands of the Boolean expression include data stored within the data platform that may be separate from the communication process flow, where the result satisfies the Boolean expression.

Some examples of the method, apparatus, and non-transitory computer-readable medium described herein may further include operations, features, means, or instructions for displaying, via a first user interface, a set of analytics corresponding to data associated with the result of the one or more paths satisfying the goal.

In some examples of the method, apparatus, and non-transitory computer-readable medium described herein, receiving the first user input that indicates the goal for the set of multiple paths may include operations, features, means, or instructions for receiving, via a first user interface, an indication of a one or more data records of a set of multiple data records stored within the data platform, an indication of one or more data record fields of the one or more data records, an indication of one or more goal conditions that may be based on one or more values of the one or more data record fields, or any combination thereof.

In some examples of the method, apparatus, and non-transitory computer-readable medium described herein, the creation of a communication process flow may include operations, features, means, or instructions for receiving, prior to receiving the first user input, one or more second user inputs that indicates at least two first action variations of a first action of the set of multiple actions and at least two second action variations of a second action of the set of multiple actions, the communication process flow including the set of multiple paths based on receiving the one or more second user inputs, where the set of multiple paths may be for a set of multiple combinations of the at least two first action variations and the at least two second action variations.

The following provides an overview of aspects of the present disclosure:

Aspect 1: A method for data processing, comprising: receiving an indication of a creation of a communication process flow comprising a plurality of actions that control electronic communications between an entity and a plurality of users, the communication process flow comprising a plurality of paths for the plurality of actions; receiving a first user input that indicates a goal for the plurality of paths of the communication process flow, the goal being based at least in part on data stored within a data platform that is separate from the communication process flow; routing at least a subset of the plurality of users via one or more paths of the plurality of paths based at least in part on a result of the one or more paths satisfying the goal for the plurality of paths of the communication process flow; and distributing a subset of the electronic communications to the subset of the plurality of users in accordance with the one or more paths.

Aspect 2: The method of aspect 1, further comprising: receiving an indication that the result of the one or more paths has a higher likelihood of satisfying the goal relative to a remaining one or more paths of the plurality of paths of the communication process flow, wherein routing the subset of the plurality of users via the one or more paths is based at least in part on receiving the indication.

Aspect 3: The method of any of aspects 1 through 2, wherein receiving the first user input that indicates the goal for the plurality of paths comprises: receiving one or more first user inputs that indicate two or more goals for the plurality of paths of the communication process flow, the two or more goals comprising the goal.

Aspect 4: The method of aspect 3, wherein receiving the one or more first user inputs comprises: receiving respective weight indications for the two or more goals, wherein each goal of the two or more goals is assigned respective weight.

Aspect 5: The method of any of aspects 1 through 4, further comprising: transmitting, to a machine learning model, a first indication of the goal and that the result of the one or more paths satisfy the goal; and receiving, from the machine learning model, a second indication of a second goal for the plurality of paths of the communication process flow that is different from the goal based at least in part on transmitting the first indication to the machine learning model, the second goal being based at least in part on the data stored within the data platform, wherein the subset of the plurality of users are routed via the one or more paths of the plurality of paths based at least in part on the result of the one or more paths satisfying the goal for the plurality of paths, the second goal for the plurality of paths, or both.

Aspect 6: The method of any of aspects 1 through 5, wherein routing at least a subset of the plurality of users comprises: routing the subset based at least in part on data within the data platform for one or more prior users subject to the communication process flow satisfying one or more conditions of the goal.

Aspect 7: The method of aspect 6, wherein the goal is specified as a Boolean expression and operands of the Boolean expression comprise data stored within the data platform that is separate from the communication process flow, wherein the result satisfies the Boolean expression.

Aspect 8: The method of any of aspects 1 through 7, further comprising: displaying, via a first user interface, a set of analytics corresponding to data associated with the result of the one or more paths satisfying the goal.

Aspect 9: The method of any of aspects 1 through 8, wherein receiving the first user input that indicates the goal for the plurality of paths comprises: receiving, via a first user interface, an indication of a one or more data records of a plurality of data records stored within the data platform, an indication of one or more data record fields of the one or more data records, an indication of one or more goal conditions that are based at least in part on one or more values of the one or more data record fields, or any combination thereof.

Aspect 10: The method of any of aspects 1 through 9, wherein the creation of a communication process flow comprises: receiving, prior to receiving the first user input, one or more second user inputs that indicates at least two first action variations of a first action of the plurality of actions and at least two second action variations of a second action of the plurality of actions, the communication process flow comprising the plurality of paths based at least in part on receiving the one or more second user inputs, wherein the plurality of paths are for a plurality of combinations of the at least two first action variations and the at least two second action variations.

Aspect 11: An apparatus for data processing, comprising one or more memories storing processor-executable code, and one or more processors coupled with the one or more memories and individually or collectively operable to execute the code to cause the apparatus to perform a method of any of aspects 1 through 10.

Aspect 12: An apparatus for data processing, comprising at least one means for performing a method of any of aspects 1 through 10.

Aspect 13: A non-transitory computer-readable medium storing code for data processing, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving an indication of a creation of a communication process flow comprising a plurality of actions that control electronic communications between an entity and a plurality of users, the communication process flow comprising a plurality of paths for the plurality of actions;
receiving a first user input that indicates a goal for the plurality of paths of the communication process flow, the goal being based at least in part on data stored within a data platform that is separate from the communication process flow;
routing at least a subset of the plurality of users via one or more paths of the plurality of paths based at least in part on a result of the one or more paths satisfying the goal for the plurality of paths of the communication process flow; and
distributing a subset of the electronic communications to the subset of the plurality of users in accordance with the one or more paths.

2. The method of claim 1, further comprising:
receiving an indication that the result of the one or more paths has a higher likelihood of satisfying the goal relative to a remaining one or more paths of the plurality of paths of the communication process flow, wherein routing the subset of the plurality of users via the one or more paths is based at least in part on receiving the indication.

3. The method of claim 1, wherein receiving the first user input that indicates the goal for the plurality of paths comprises:
receiving one or more first user inputs that indicate two or more goals for the plurality of paths of the communication process flow, the two or more goals comprising the goal.

4. The method of claim 3, wherein receiving the one or more first user inputs comprises:
receiving respective weight indications for the two or more goals, wherein each goal of the two or more goals is assigned respective weight.

5. The method of claim 1, further comprising:
transmitting, to a machine learning model, a first indication of the goal and that the result of the one or more paths satisfy the goal; and
receiving, from the machine learning model, a second indication of a second goal for the plurality of paths of the communication process flow that is different from the goal based at least in part on transmitting the first indication to the machine learning model, the second goal being based at least in part on the data stored within the data platform, wherein the subset of the plurality of users are routed via the one or more paths of the plurality of paths based at least in part on the result of the one or more paths satisfying the goal for the plurality of paths, the second goal for the plurality of paths, or both.

6. The method of claim 1, wherein routing at least a subset of the plurality of users comprises:
routing the subset based at least in part on data within the data platform for one or more prior users subject to the communication process flow satisfying one or more conditions of the goal.

7. The method of claim 6, wherein the goal is specified as a Boolean expression and operands of the Boolean expression comprise data stored within the data platform that is separate from the communication process flow, wherein the result satisfies the Boolean expression.

8. The method of claim 1, further comprising:
displaying, via a first user interface, a set of analytics corresponding to data associated with the result of the one or more paths satisfying the goal.

9. The method of claim 1, wherein receiving the first user input that indicates the goal for the plurality of paths comprises:
receiving, via a first user interface, an indication of a one or more data records of a plurality of data records stored within the data platform, an indication of one or more data record fields of the one or more data records, an indication of one or more goal conditions that are based at least in part on one or more values of the one or more data record fields, or any combination thereof.

10. The method of claim 1, wherein the creation of a communication process flow comprises:
receiving, prior to receiving the first user input, one or more second user inputs that indicates at least two first action variations of a first action of the plurality of actions and at least two second action variations of a second action of the plurality of actions, the communication process flow comprising the plurality of paths based at least in part on receiving the one or more second user inputs, wherein the plurality of paths are for a plurality of combinations of the at least two first action variations and the at least two second action variations.

11. An apparatus for data processing, comprising:
one or more memories storing processor-executable code; and
one or more processors coupled with the one or more memories and individually or collectively operable to execute the code to cause the apparatus to:
receive an indication of a creation of a communication process flow comprising a plurality of actions that control electronic communications between an entity and a plurality of users, the communication process flow comprising a plurality of paths for the plurality of actions;
receive a first user input that indicates a goal for the plurality of paths of the communication process flow, the goal being based at least in part on data stored within a data platform that is separate from the communication process flow;
route at least a subset of the plurality of users via one or more paths of the plurality of paths based at least in part on a result of the one or more paths satisfying the goal for the plurality of paths of the communication process flow; and
distribute a subset of the electronic communications to the subset of the plurality of users in accordance with the one or more paths.

12. The apparatus of claim 11, wherein the one or more processors are individually or collectively further operable to execute the code to cause the apparatus to:
receive an indication that the result of the one or more paths has a higher likelihood of satisfying the goal relative to a remaining one or more paths of the plurality of paths of the communication process flow, wherein routing the subset of the plurality of users via the one or more paths is based at least in part on receiving the indication.

13. The apparatus of claim 11, wherein, to receive the first user input that indicates the goal for the plurality of paths, the one or more processors are individually or collectively operable to execute the code to cause the apparatus to:
receive one or more first user inputs that indicate two or more goals for the plurality of paths of the communication process flow, the two or more goals comprising the goal.

14. The apparatus of claim 11, wherein the one or more processors are individually or collectively further operable to execute the code to cause the apparatus to:
transmit, to a machine learning model, a first indication of the goal and that the result of the one or more paths satisfy the goal; and
receive, from the machine learning model, a second indication of a second goal for the plurality of paths of the communication process flow that is different from the goal based at least in part on transmitting the first indication to the machine learning model, the second goal being based at least in part on the data stored within the data platform, wherein the subset of the plurality of users are routed via the one or more paths of the plurality of paths based at least in part on the result of the one or more paths satisfying the goal for the plurality of paths, the second goal for the plurality of paths, or both.

15. The apparatus of claim 11, wherein, to creation of a communication process flow, the one or more processors are individually or collectively operable to execute the code to cause the apparatus to:
receive, prior to receiving the first user input, one or more second user inputs that indicates at least two first action variations of a first action of the plurality of actions and at least two second action variations of a second action of the plurality of actions, the communication process flow comprising the plurality of paths based at least in part on receiving the one or more second user inputs, wherein the plurality of paths are for a plurality of combinations of the at least two first action variations and the at least two second action variations.

16. A non-transitory computer-readable medium storing code for data processing, the code comprising instructions executable by one or more processors to:
receive an indication of a creation of a communication process flow comprising a plurality of actions that control electronic communications between an entity and a plurality of users, the communication process flow comprising a plurality of paths for the plurality of actions;
receive a first user input that indicates a goal for the plurality of paths of the communication process flow, the goal being based at least in part on data stored within a data platform that is separate from the communication process flow;
route at least a subset of the plurality of users via one or more paths of the plurality of paths based at least in part on a result of the one or more paths satisfying the goal for the plurality of paths of the communication process flow; and
distribute a subset of the electronic communications to the subset of the plurality of users in accordance with the one or more paths.

17. The non-transitory computer-readable medium of claim 16, wherein the instructions are further executable by the one or more processors to:
receive an indication that the result of the one or more paths has a higher likelihood of satisfying the goal relative to a remaining one or more paths of the plurality of paths of the communication process flow, wherein routing the subset of the plurality of users via the one or more paths is based at least in part on receiving the indication.

18. The non-transitory computer-readable medium of claim 16, wherein the instructions to receive the first user input that indicates the goal for the plurality of paths are executable by the one or more processors to:
receive one or more first user inputs that indicate two or more goals for the plurality of paths of the communication process flow, the two or more goals comprising the goal.

19. The non-transitory computer-readable medium of claim 16, wherein the instructions are further executable by the one or more processors to:
transmit, to a machine learning model, a first indication of the goal and that the result of the one or more paths satisfy the goal; and
receive, from the machine learning model, a second indication of a second goal for the plurality of paths of the communication process flow that is different from the goal based at least in part on transmitting the first indication to the machine learning model, the second goal being based at least in part on the data stored within the data platform, wherein the subset of the plurality of users are routed via the one or more paths of the plurality of paths based at least in part on the result of the one or more paths satisfying the goal for the plurality of paths, the second goal for the plurality of paths, or both.

20. The non-transitory computer-readable medium of claim 16, wherein the instructions to creation of a communication process flow are executable by the one or more processors to:
receive, prior to receiving the first user input, one or more second user inputs that indicates at least two first action variations of a first action of the plurality of actions and at least two second action variations of a second action of the plurality of actions, the communication process flow comprising the plurality of paths based at least in part on receiving the one or more second user inputs, wherein the plurality of paths are for a plurality of combinations of the at least two first action variations and the at least two second action variations.
